(19) United States
(12) Patent Application Publication
(10) Pub. No.: US 2015/0199453 A1
(43) Pub. Date: Jul. 16, 2015

(54) METHOD AND SYSTEM FOR EFFICIENT ATTRIBUTES MANAGEMENT OF PRODUCT DESIGNS

(71) Applicant: TATA TECHNOLOGIES PTE LIMITED, Singapore (SG)

(72) Inventors: VISHESH GOEL, PUNE (IN); VISHAL GADE, PUNE (IN); HARISH SHEWALE, PUNE (IN); VINAYAK GAPCHUP, PUNE (IN)

(73) Assignee: TATA TECHNOLOGIES PTE LIMITED, Singapore (SG)

(21) Appl. No.: 14/207,649

(22) Filed: Mar. 13, 2014

(30) Foreign Application Priority Data
Jan. 10, 2014 (IN) 87/MUM/2014

(51) Int. Cl. G06F 17/50; G06Q 10/06

(52) U.S. Cl. CPC G06F 17/50; G06Q 10/067

(57) ABSTRACT

A system and method for Efficient Attributes Management of Product Designs, whereby hierarchy levels are assigned to assembly stages of the product at production line, revision is incorporated in all hierarchy levels up to product level for any engineering change, attributes of parts and assemblies of products under design are transacted with product life cycle management at collective level and not constrained to transact at part level. Also, the system makes it possible to incorporate multi-hierarchy engineering change revisions en mass, as per organizational requirement and practice. The system modularizes attributes transaction action so as to reduce time of usage of PLM tool as well as person for higher value added work.

### FIELD OF THE INVENTION

The present invention relates to management of details or attributes of product designs, sub-assemblies and components thereof. Particularly, the invention relates to efficient management of attributes of product design, sub-assemblies and components for life cycle management of product designs. Also, the invention relates to efficient management of attributes of a product, sub-assemblies and components for life cycle management of a product design, which is a computer aided designed and engineered product.

### BACKGROUND OF THE INVENTION

Any physical product consists of a number of components or parts. Example: a mixer grinder which would have around a hundred discrete components; or an aircraft which would have few thousand components.

Components are joined together to form sub-sub assemblies and sub-assemblies; and various such sub-assemblies when joined together make a product. Let us understand with an example: A Head Lamp Assembly of a car shall consist of a shell, cover, reflector, wires, bulb holder, terminals, bulb and few screws. Bulb holder shall be joined with wire and terminals. This is example of a sub-sub-assembly, named here as terminal assembly. By fitting a bulb, it shall become a sub-assembly, named here as bulb holder assembly. Bulb holder assembly then shall be filled in the shell using two screws, keeping reflector in-between and then cover shall be mounted on top using screws so as to complete the Head Lamp assembly.

Each product, sub-assembly and component, that is, wire, shell, bulb, terminal assembly, etc. has several details associated with it example—Configuration or Part, Identification Number, Revision Number, project identifier, status indicator, owner. Each detail is generally known as an attribute. Every component, sub-sub assembly, sub-assembly and the product have few to few tens of attributes.

Attributes are essentially needed for proper identification, relation and association of each and every component and assemblies amongst one another, with the product, also with associated team, and the organization.

Attributes are different than design and performance parameters described in design drawings and related documents, examples—dimensions, tolerances, material specification, functional constraints, and regulatory information, etc. Design and performance parameters have a direct bearing on attributes, although there is no reverse relationship. Attributes amongst themselves have complex relationship, though less exploited due to unavailability of structured management system.

Attributes keep changing and need to be dynamically updated. Revision number is one of the most significant attribute which changes consequent to engineering changes. Engineering changes are caused by several triggers like, product improvement/enhancement, cost reduction, solving a field problem, making provision for alternate materials, etc.

Let us take a situation to elaborate—Changing cross-section of wire, in above example, in order to run the wire at lower temperature, is a design parameter change. Besides incorporating technical change in specification, this change is captured in attributes by changing the revision number of the drawing of wire, which is an attribute change.

Change in revision number of a component or sub-sub assembly at an actual part and assembly stage apparently does not warrant change elsewhere but we shall notice later below as to how such a change impacts entire product and its significance in managing engineering change and product quality.

A less appreciated attribute which changes is assembly stage. Assembly stage denotes the stage at which a component gets assembled within a product. Assembly stage is initially decided by product designers based on conceived assembly sequence. However, it gets changed depending on practical manufacturing convenience and productivity, which is better understood by manufacturing personnel who actually produce the product in volumes. Also, different manufacturing personnel have different views for better productivity and prefer to re-arrange assembly stages as per their perception.

During the product design stage itself, there are large number of design parameter and attributive changes in the course of verification, validation and peer reviews, which need to be tracked with same attention as during the life cycle of product.

It is therefore important to understand that attributes of components, sub-assemblies, sub-assemblies change in no particular known manner.

Product management tools, also known as product life cycle management tools, abbreviated as PLM tools, are well known for managing attributes related information, and generating outputs like bill of material, where used information, link with enterprise resource planning etc., which serve as basis for all project related decision making PLM tools are particularly indispensible for product designs with large number of parts—typically running into few tens, upwards.

Consequent to unpredictable nature of relation and change of attributes with respect to product, most PLM tools handle attributes individually, that is component by component. This implies that the designer is required to individually input each and every new and or changed attribute in PLM tools. Designers, as part of conceptualization and documentation process, generally prepare attributes data with respect to each part, different levels of assemblies, and product; however, current PLM tools do not facilitate transacting in the same manner. This necessitates additional care in feeding and handling attributes details field by field, huge investment of time with PLM tool, as well as of the person involved.

Due to available PLM tools not facilitating en mass attributes transaction for product or sub-assemblies or even parts, many organizations take it to be the standard practice of not relating revision number with higher stage assemblies. Example—Assume that the length of wire in the above example is required to be increased by few millimeters. Consequent to this design change, the revision number of drawing of wire changes. Technically, this engineering change addresses the requirement and no other design parameter and or attribute change may be needed. However, there is no direct way to ascertain which car has shorter, that is, old design of wire and which car has longer, that is new design of wire. If organizations do not incorporate indicators to monitor such changes at product level, they lead themselves into uncalculated risk of losing control on change management and product quality. This is serious, since it shall be impossible to know whether a complaint or improvement of any car, is with old design of wire or new design of wire; and consequently, it shall be difficult to discriminate or isolate and limit any product liability aspects due to related failures.

In real life scenario of product development, for example, of an automobile say a car, there are few thousand parts and assemblies, assembled at say fifty or so different assembly stages. For organized manufacturing and production, defining of appropriate assembly stage and number of parts in any assembly at design stage and subsequently is important step for taking a design from design office to manufacturing shops. Iterative correction is uncompromisingly required in the attributes based on feedback of different personnel involved.

Large number of components and assemblies undergo design changes consequent to engineering changes required to meet expanding product requirement due to rapidly changing competitive scenario. Each engineering change is a pointer of product change. The higher the numerical part count, the more important is attributes management at product level.

There are known methods of revision number management at part level. Assembly stage management is also a known science and practice. There are significant advancements in the version management, as can be noted in the patent publication number EP0483039A2. What is missing is connecting these pointers with product so that an organization exactly knows which product has left the factory with which design parameter of each and every component, irrespective of number of components, production volumes and time of shipment. In absence of this core information, it is virtually impossible to ascertain and assess impact of any design parameter retrospectively.

An organized and flexible product level attributes management is therefore dire need of every organization and industry.

Our invention solves these problems.

### OBJECTIVE OF THE INVENTION

The objective is to invent a system and method of attributes management of product design which addresses attributes of product design at collective level with product life cycle management in consonance with needs of traceability of product performance and quality.

The objective also is to invent a system and method of attributes management of product design which makes it possible to transact attributes of product design at collective level with product life cycle management tools in consonance with needs of product performance and quality and not constrained to transact at component or part level.

Another objective is to invent a system and method of attributes management of product design which makes it possible to incorporate attributes related to bulk engineering change revisions corresponding to assembly stages and as per organizational requirement and practice.

Yet another objective is to modularize attributes transaction action so as to reduce time of usage of PLM tool for higher value added work.

Yet another objective is to modularize attributes transaction action so as to save time of product designers for higher value added work.

### SUMMARY OF INVENTION

Our invention is a method for efficient attribute management of product designs and is a system to transact and execute product level attributes, en mass. Attribute is the detail associated with each product, sub-assembly and component or part.

The method captures assembly stage, which means the interim stage during the production process at which assembly of certain components is undertaken at the production line, which therefore is a physical action at production line, as a performance and thus design parameter. The said method assigns to this design parameter an attribute termed as hierarchy level. The end product, which is the complete assembly, is taken as highest hierarchy and is termed as hierarchy level ZERO. Natural numbers 1, 2, 3, . . . are used as hierarchy levels for further assemblies, sub assemblies and sub-sub assemblies, till the last component level.

Configuration implies product or assembly or sub-assembly involving more than one part, while individual parts are considered as constituents of configurations.

There shall be a unique Identification number or identifier corresponding to end product at hierarchy level ZERO. Likewise, there shall be a unique Identification number or identifier for assemblies or sub-assemblies, which are also called Configuration, at hierarchies 1 and more. There also shall be identification numbers at further hierarchy levels, corresponding to each and every part. Also, each configuration and part shall have its own revision number. Revision number signifies the number of instances when there has been a change in one or more design parameters.

For any upward or downward change in assembly stage of a component or sub-sub assembly or sub-assembly, it is customary to change revision number at that stage as per practice in different organizations. According to this method, there shall also be change in revision number in ALL the hierarchy levels up to product level, in the same hierarchy chain, but not in the hierarchy sideward or further downwards.

For any change in the design parameter, it is customary to change revision number for corresponding part or assembly as per practice in different organizations. According to this method, there shall also be change in revision number of higher level assembly documents in ALL the hierarchy levels up to product level, in the same hierarchy chain, but not in the hierarchy downwards or sideward.

Method as described above, while ensures complete traceability and therefore facilitates quality management, nonetheless, generates large and repetitive cumbersome work of incorporating, changing, monitoring and thus managing the attributes, particularly revision and hierarchy attributes.

Our invention, therefore, includes a system by way of a computer program. The computer program is a “plug-in” , which means that it is insert-able in compatible tools. Our “plug-in” is insert-able in known Product Life Cycle Management (PLM) tools, which have provision of patching in a stand-alone and specific application oriented computer program, and thus generally known as “plug-in”. The “plug-in” is specific to and suitable for respective PLM tools and the hardware on which respective PLM tools are installable.

The “plug-in” makes possible bulk execution of attributes in several, including but not limited to following, gross functions:
(1) Creation of new configurations
(2) Bulk or individual Record Accessing
(3) Bulk Updating
(4) Export of Configurations

Attributes as per above method are tabulated as writable and readable inputs in known tabulation tools like Microsoft EXCEL, Microsoft Access or Notepad, etc.. The “plug-in” has selectable options by which the attributes are uploaded to, downloaded from or displayed/reported and or exported from database of PLM tool.

Our “plug-in” causes validation of data in tabulation tool, as per rules incorporated. Error log and feedback is generated along with requisitioned output.

Furthermore, consequent to our system enabling en mass execution, designers can create, without having to work harder, further interlocking cross-intelligence between attributes to extract interdependent information impacting product management. For example, relation between owner and revision can be built in order to extract information related to person specific revision, which is significant for linking engineering skill with product performance.

### BRIEF DESCRIPTION OF DRAWINGS

FIG. 1 shows an illustrative product—Head Lamp of automobile. Different parts and complete Head Lamp there form, are represented. Head lamp assembly is taken as a product for illustration, which is a Configuration.

FIG. 2 shows the same product with different parts and sub-assemblies arranged in the order of illustrative assembly stages.

FIG. 3 shows the same product with correspondingly assigned hierarchy levels.

FIG. 4 shows illustrative attributes tabulated pertaining to illustrative product assembly.

FIG. 5 shows hierarchy levels as another tabulated attribute corresponding to assembly stages given in FIG. 2.

FIGS. 6 and 6A (in continuation) is flow diagram showing execution steps in creation of new configuration.

FIG. 7, 7A show feedback and error logs when new configuration is created using said plug-in.

FIG. 8 is flow diagram showing execution steps in bulk or individual record accessing. FIG. 8A shows the illustrative output.

FIGS. 9 and 9A (in continuation) is flow diagram showing execution steps in bulk updating.

FIG. 10 shows product assembly with additional and new component of different wire.

FIG. 11 shows corresponding attribute tabulated.

FIG. 12 shows product assembly with change of hierarchy of wire.

FIG. 13 shows corresponding attribute tabulated.

FIGS. 14 and 14A (in continuation) is flow diagram showing execution steps in bulk export of attributes from PLM tool to Tabulation Tool.

FIG. 15, 16 show gross relation and higher level integration aspect between plug-in, PLM tool and Tabulation Tool.

FIG. 17 shows plug-in on menu bar (39) of a PLM tool—“iArrange” and drop down options.

### DETAILED DESCRIPTION OF INVENTION

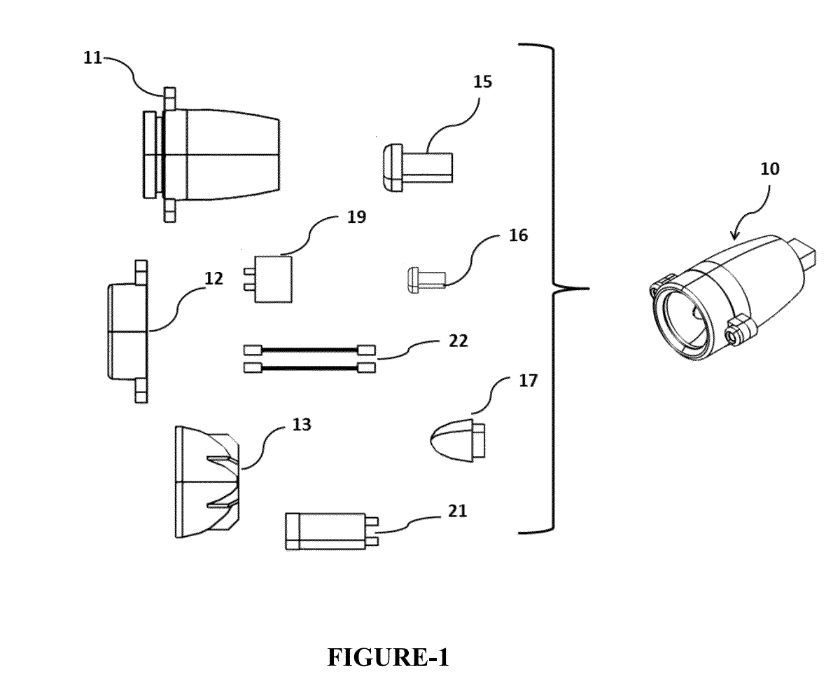

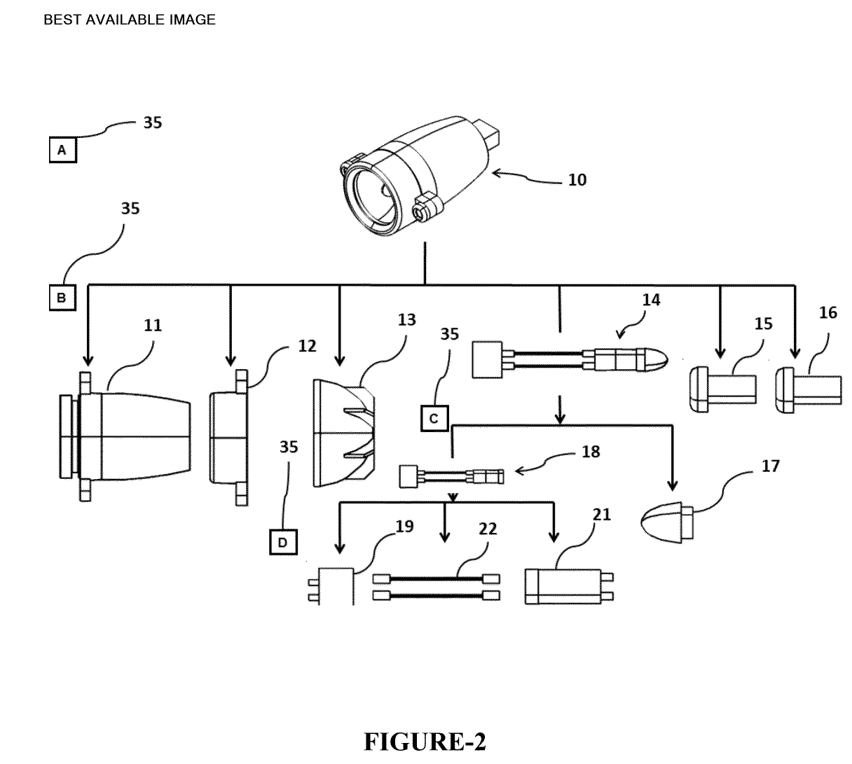

The invention shall now be described with the aid of earlier illustrated product—Head Lamp Assembly (10). FIG. 1 shows all parts of Head Lamp Assembly (10) in random order. FIG. 2 shows the parts and sub-assemblies in a typical manufacturing or assembly sequence. Thus, the Head lamp assembly (10) comprises of five components—shell (11), cover (12), reflector (13), screws (15) and (16); and a sub assembly—bulb holder assembly (14). Bulb holder assembly (14) in turn consists of one part—bulb (17) and a sub-sub assembly—terminal assembly (18). Terminal assembly (18) is made up of three parts—terminals (19), wires (22) and holder (21).

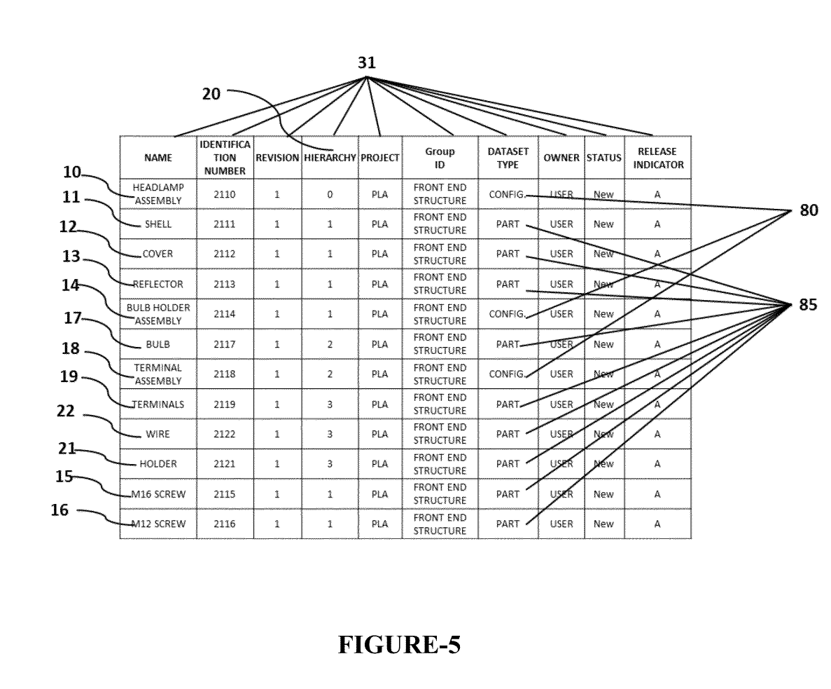

Attribute (31), is the detail associated with each product, sub-assembly and component or part, as illustrated in FIG. 5 and referred to throughout the description.

Four assembly stages (35) at production line are assumed in this illustration and shown in FIG. 2 as Assembly stages A,B,C and D. Material manufactured at assembly stage D is needed in order to manufacture material at assembly stage C, which in turn is needed to manufacture at level B, and eventually the complete usable and or sellable product is ready at level A.

Head Lamp Assembly (10) is considered here as an end product, notated as a Configuration (80). Configuration (80) here generally implies product or assembly or sub-assembly involving more than one part, while individual parts (85) are considered as constituents of configurations (80).

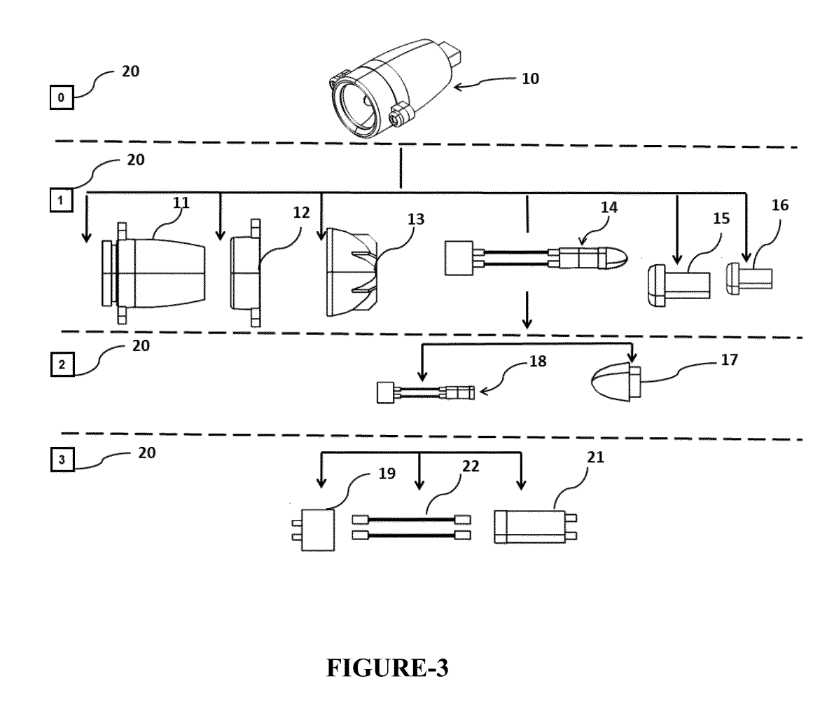

Corresponding to assembly stages (35) which are a design parameter, hierarchy levels (20) are created, FIG. 3, which is essentially an attribute (31). To produce Head lamp assembly (10), which is considered at level “0” of hierarchy (20), all the parts and sub-assemblies shown at level “1” of hierarchy (20) are required. Likewise, to produce product sub-assemblies shown at level “1” of hierarchy (20), all the parts and sub-sub assemblies shown at level “2” of hierarchy (20) are required.

Every configuration (80) and part (85) in a product design has a number of non-technical details associated with it, describing it. These are all collectively termed as attributes (31). Attributes (31) are essentially needed for proper identification, relation and association of each and every component and assemblies amongst one another, with the product, also with design team and the organization.

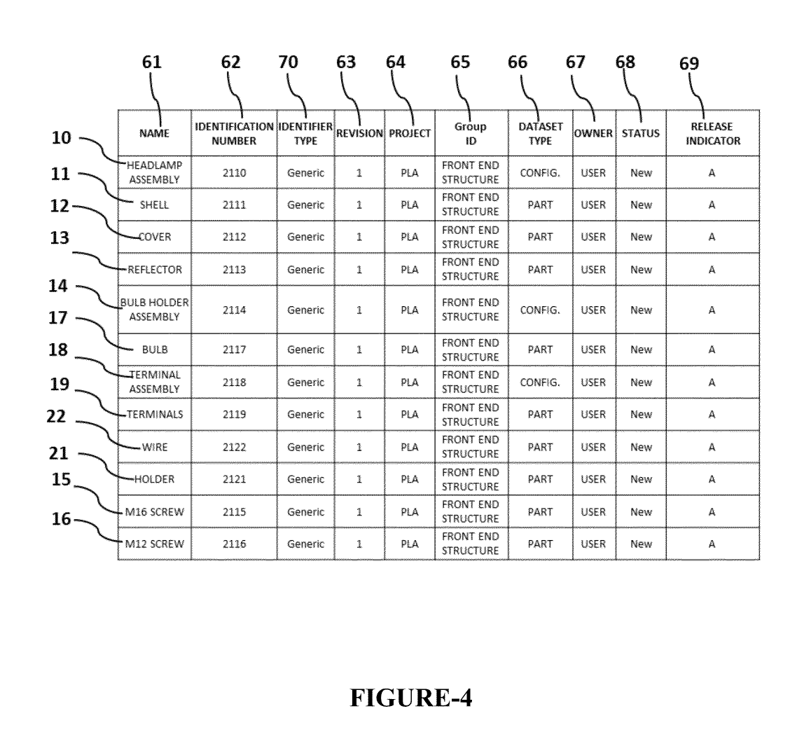

Attributes (31), include, besides name of the part (61), a unique Identification number (62), revision (63), project (64), group ID (65), dataset type (66), owner (67), status (68), release indicator (69), identifier type (70), etc. An illustration is given in FIG. 4 for attributes of parts and configurations of illustrative product Head Lamp Assembly (10).

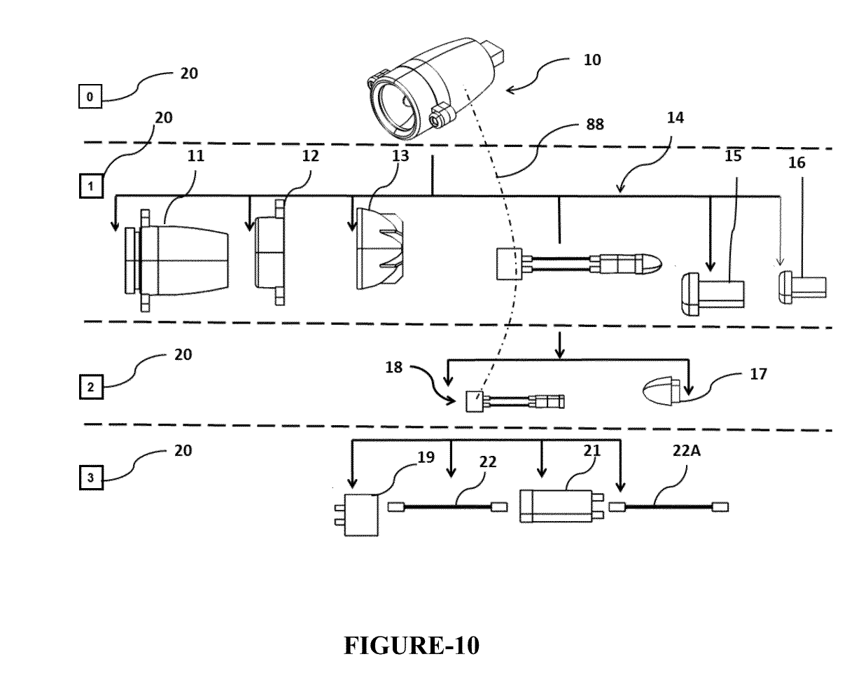

To describe our invention, let us now introduce a design change. Wires (22), which were earlier two identical wires, is required to be changed to wires of two different colors. FIG. 10 reflects this change, showing new wire (22A). This change would necessitate
(1) Incorporating new drawing of wire (22A) of another color—this is a design change.
(2) Reducing quantity of earlier wire (22) from two per assembly to one per assembly.
(3) Incorporating all attributes (31) related to new wire (22A).
(4) Incorporating design details of new wire (22A) in drawing of terminal assembly (18) and changing revision number (63).

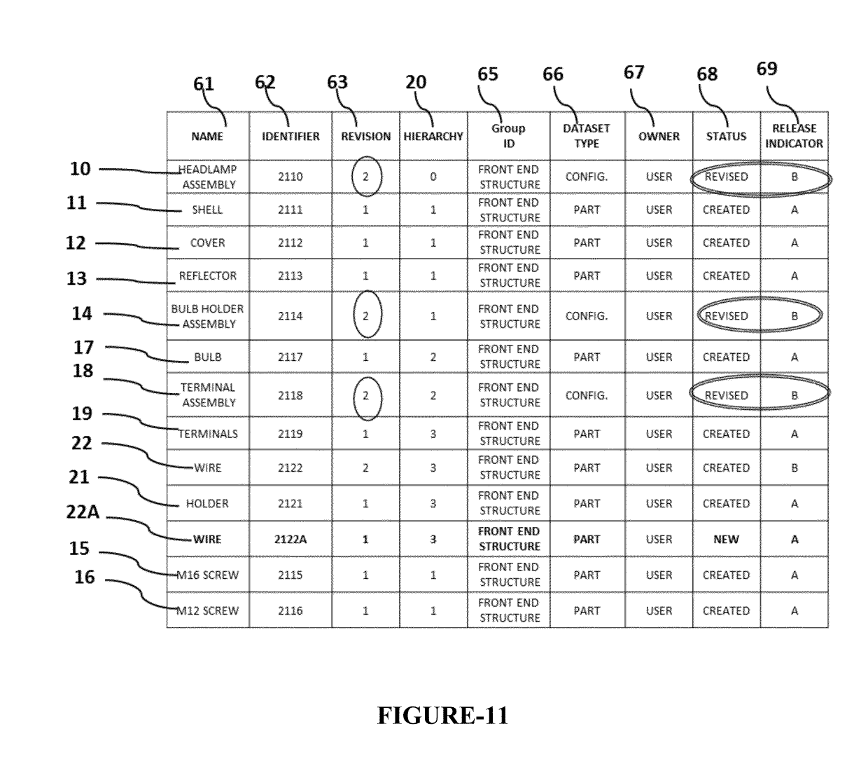

Additionally, now, revision numbers (63) of bulb holder assembly (14) as well as revision number (63) of main head lamp assembly (10) shall also change, as depicted by hierarchy chain (88). This change is to generate an indicator that new head amp assembly (10) is technically different than old head lamp assembly (10). FIG. 11 reflects above changes.

In this illustrative case, head lamp assembly (10) is considered at hierarchy level “0”; however, if an automobile, say a car, is considered as product, then in that case, revision numbers (63) of all assemblies involving head lamp assembly (10), till the car shall also need to change.

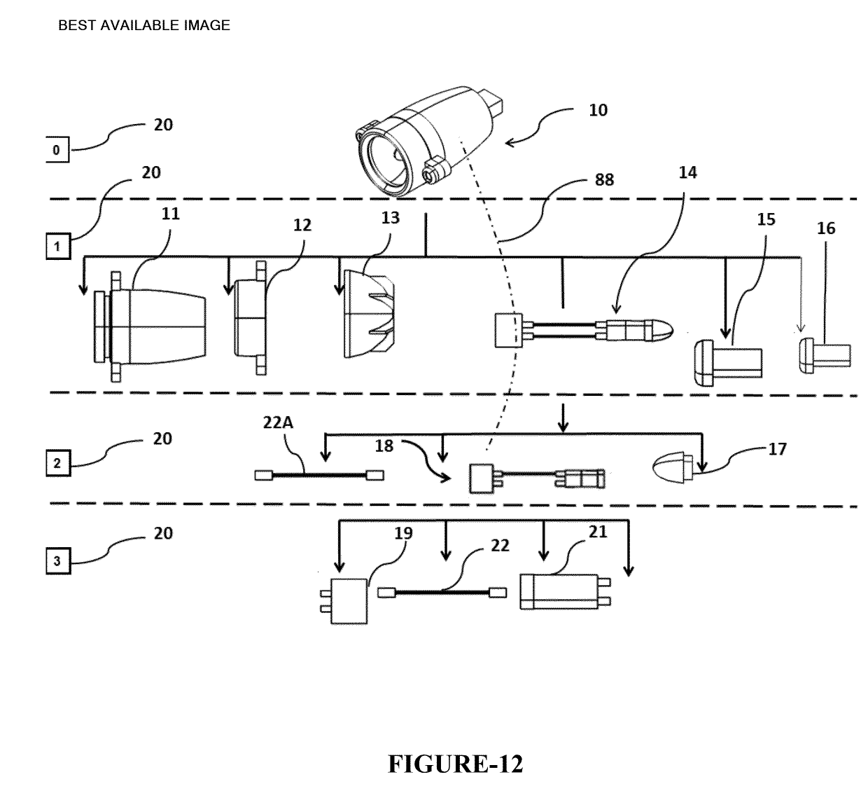

Let us now describe another design change which is an assembly change. The design change required is—New wire (22A) is required to be assembled by pressing and sandwiching its metallic braid (not shown) between threads of bulb (17) and holder (21). Due to this functional requirement, wire (22A) cannot be assembled at assembly stage D and has to be assembled instead at assembly stage C. FIG. 12 and FIG. 2 shows this aspect.

This change would necessitate
(1) Incorporating new assembly instructions in drawing of bulb holder assembly (14).—This is a design change. Correspondingly, changing the revision number (63) of drawing of bulb holder assembly (14).
(2) Deleting details of wire (22A) from drawing of terminal assembly (18). Correspondingly, changing the revision number of drawing of terminal assembly (18).

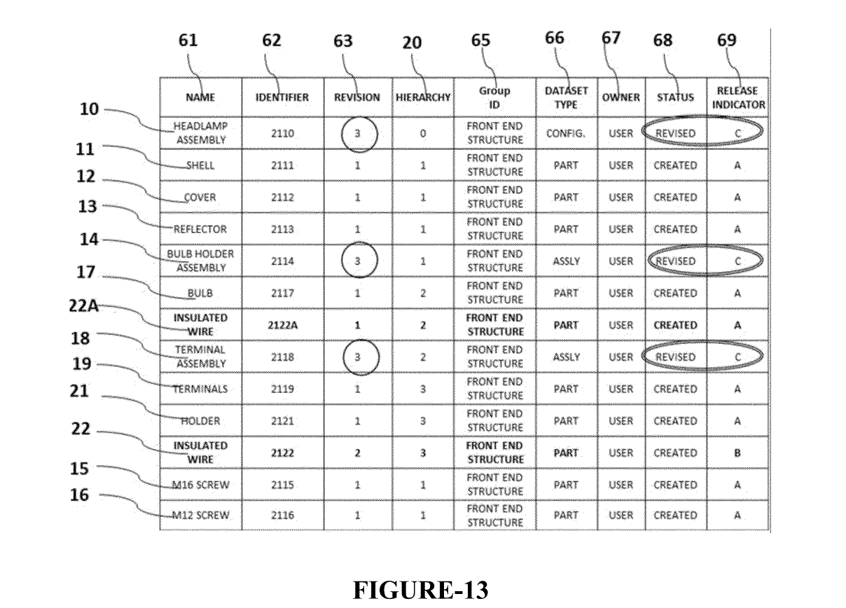

Additionally, now, as shown in FIG. 13:
(a) Hierarchy level (20) of wire (22A) shall also change from 3 to 2.
(b) Revision number (63) of main head lamp assembly (10) shall also change, as depicted by hierarchy chain (88) in FIG. 12. This change is to generate an indicator that new head amp assembly (10) is technically different than old head lamp assembly (10).

The method of incorporation of hierarchy levels (20) as attribute (31), corresponding to assembly stages (35) followed at production line and incorporation of next revision number on all the hierarchy levels up to level “0” ensures that every design aspect is traceable from product level downwards to the level at which the change is affected on the manufacturing line. This facility is of high relevance when organizations encounter product defects or failures and need to take preventive, corrective or recall actions.

Any physical product consists of a number of parts or components, varying from few tens in a product say, a mixer grinder; to a few thousand in products like an aircraft. Additions of new parts as well as changes in existing parts keep happening very frequently. Our method at times is apprehended to be resisted or unwelcome due to sheer additional non-design parameter related change management, how-so-ever beneficial and crucial for the organization it may be.

For products with large number of parts and also tens of attributes, organizations use product life cycle management (PLM) tool (50), wherein attributes are required to be entered and reside in database (47) of a product life cycle management (PLM) tool (50). The cumbersomeness of the said method still remains due to the fact that known PLM tools (50), examples “Team Center”, ENOVIA, Windchill, etc. permit entry and changes only field by field for individual parts (85) or configurations (80), and not en mass.

To ensure convenience of our method, particularly at operational level, and also to provide additional benefits in terms of (a) saving time and efforts (b) reducing needed skill set, by solving the intrinsic problem of PLM tools handling attributes discretely, our invention includes a software program. The software program acts as value added interface between tabulation tools (30) and PLM tools (50).

Furthermore, consequent to our system enabling en mass execution, designers can create, without having to work harder, further interlocking cross-intelligence between attributes at different hierarchy levels to extract interdependent information impacting product management. For example, relation between owner (67) and revision (63) can be built in order to extract information related to person specific revision, which could be used for linking engineering skill with product performance.

According to our invention, attributes (31) as per the said method and other commonly assigned attributes (31) are tabulated in known tabulation tools (30) like Microsoft EXCEL, Microsoft Access or Notepad, etc.

The said software computer program is a “plug-in” (40), which means that it is insert-able in known PLM tools (50), which have provision of patching in a stand-alone and specific application oriented computer program, generally known as “plug-in” (40). The “plug-in” (40) is specific to and suitable for respective PLM tools (50) and the hardware on which respective PLM tools (50) are installable. The “plug-in” (40) resides in PLM interface (46).

The computer program is plugged in PLM tool (50) whereby PLM tool (50) and a tabulation tool (30) transact and process attributes data of product, for example Head Lamp Assembly (10), en mass. The inventive software program is a “plug-in” (40), which means that menu bar (39) of the PLM tool reflects the feature by displaying the given name amongst other menu options of PLM tool (50). Our plug-in software program is brand named “iArrange” (41). On selecting the feature “iArrange” (41), drop down menu appears.

A product or sub-product, called configuration (80), is assigned a unique code. Every configuration (80) consists of more than one parts, and or assemblies and sub-assemblies. Each configuration (80) and part (85) has its unique identifier (62). Designers, prior to commencing work on design and functional parameters, prepares details of attributes (31), including hierarchy (20) and other parameters as illustratively written in table shown in FIG. 5.

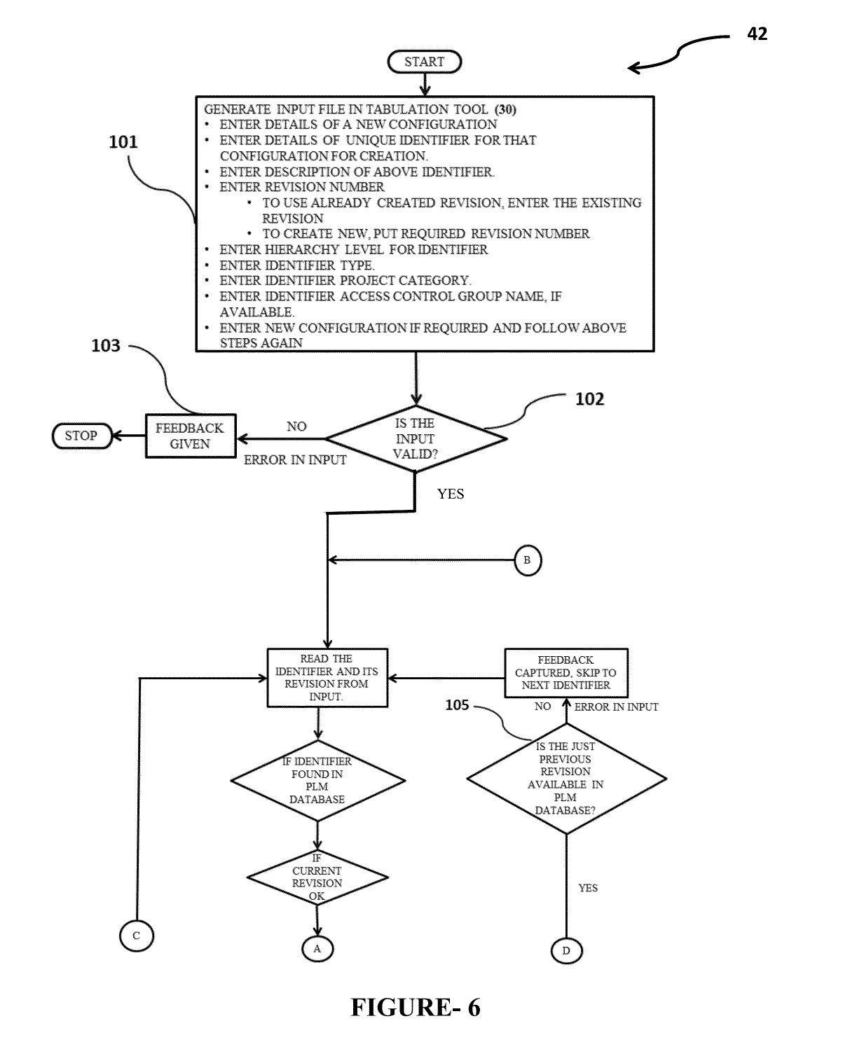

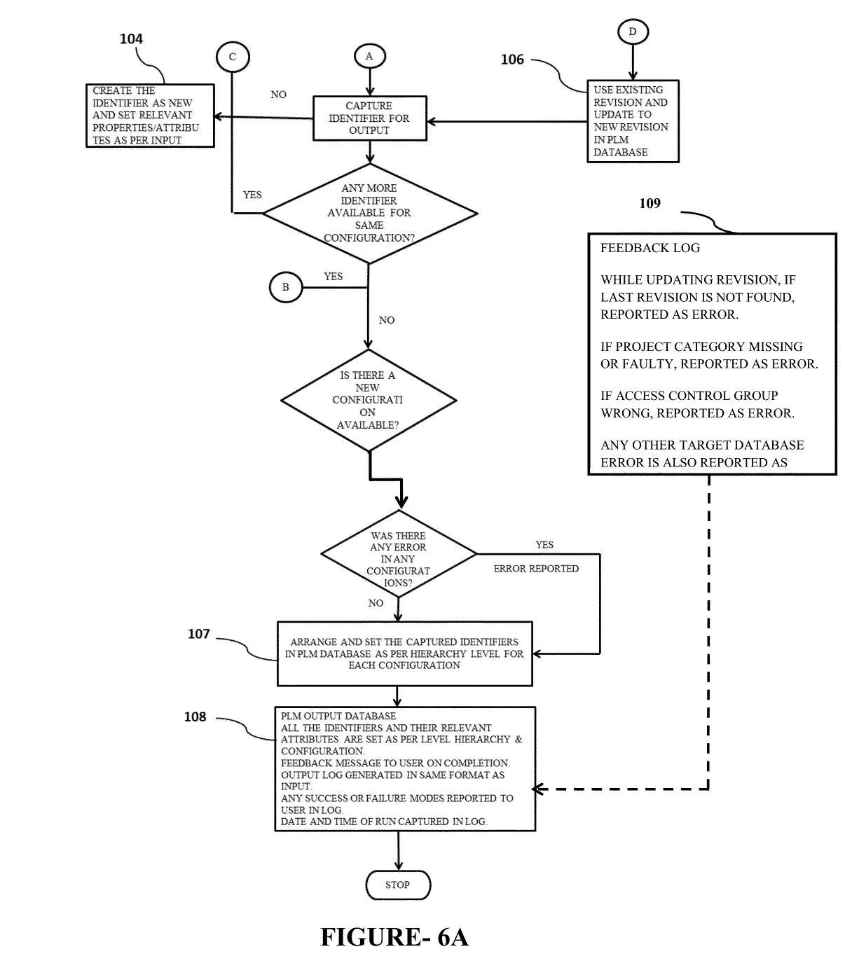

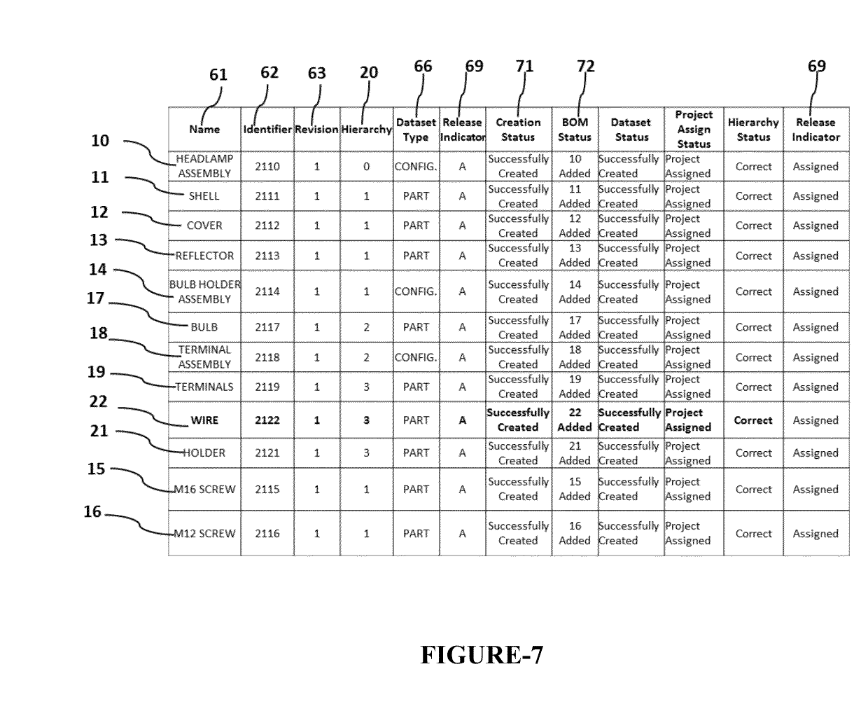

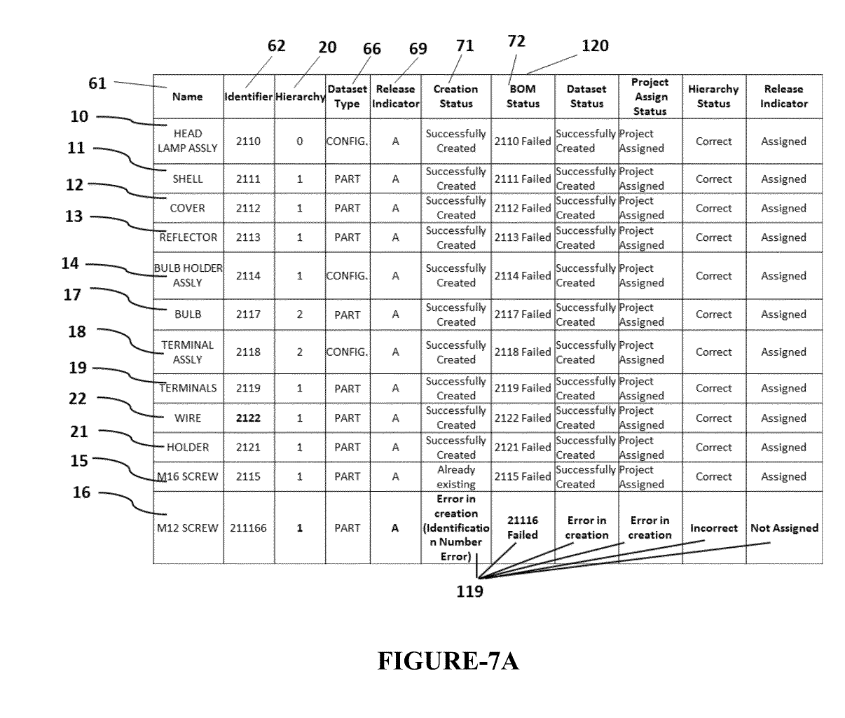

Embodiment of our invention disclosed here performs four kinds of transactions, which are described now:
Creation of new configurations (42): For making use of this system, the attributes are enlisted in the tabulation tool (30) as shown in step (101) in the flow diagram given in FIG. 6. By selecting option of “creation of new configuration” (42) from the feature “iArrange” (41), the execution takes place as per flow diagram given in FIGS. 6 and 6A. The notable steps are
   (1) On invoking the “Creation of new configuration” (42) option of “iArrange” (41), the “plug-in” (40) looks for data in tabulation tool (30).
   (2) Data in each line item is validated by PLM tool as per built-in rules (102).
   (3) For new configuration and or parts, the data is accepted (104).
   (4) For existing configurations and or parts, the revision number is updated (106) after validating with respect to previous revision (105) in the PLM database.
   (5) Mis-match is reported in the form of a log & feedback table (119), as given in FIGS. 7 and 7A.
   (6) Updated attributes against individual identifier are created in database of PLM tool (107 and 108).

The “plug-in” (40) has built-in rules and data in tabulation tool is checked (102), such that any deviations are reported as error (103 and 109), in the following illustrative situations:
Identifier number (62) is different than prescribed naming convention
Wrong Revision number (63) for any configuration or part
User has no read and or write access to the group mentioned
User has no access to the assigned project or program

As particularly shown in FIG. 7A, in case of any error (119) in creation of configuration (80) or part (85), the complete configuration (80) is not created (120) and the error is reported in BOM creation. If at any point there is a disconnection with the PLM database due to network failure then also complete configuration (80) is not created (120) and error is reported in BOM creation.

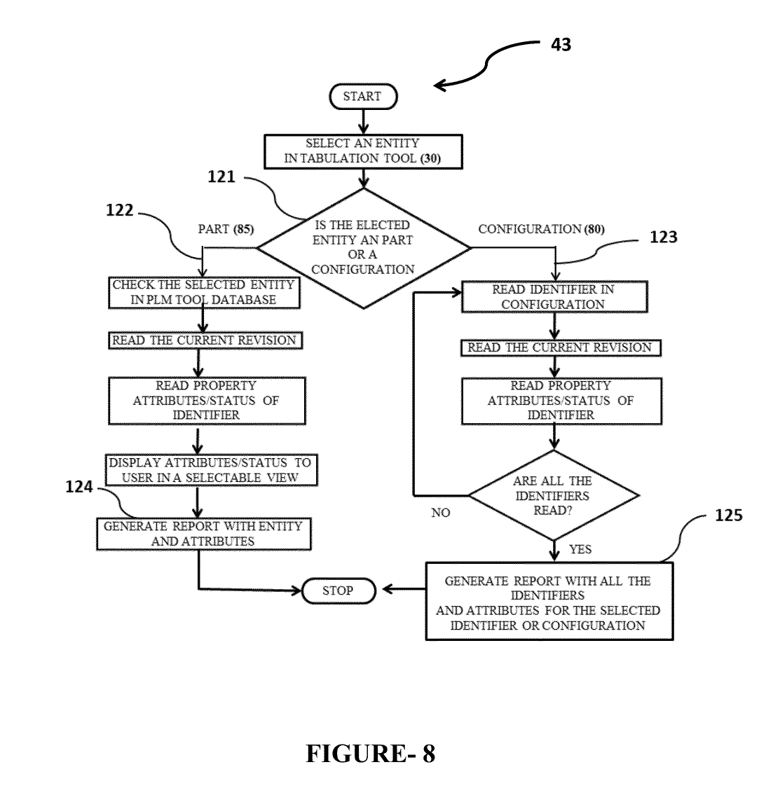

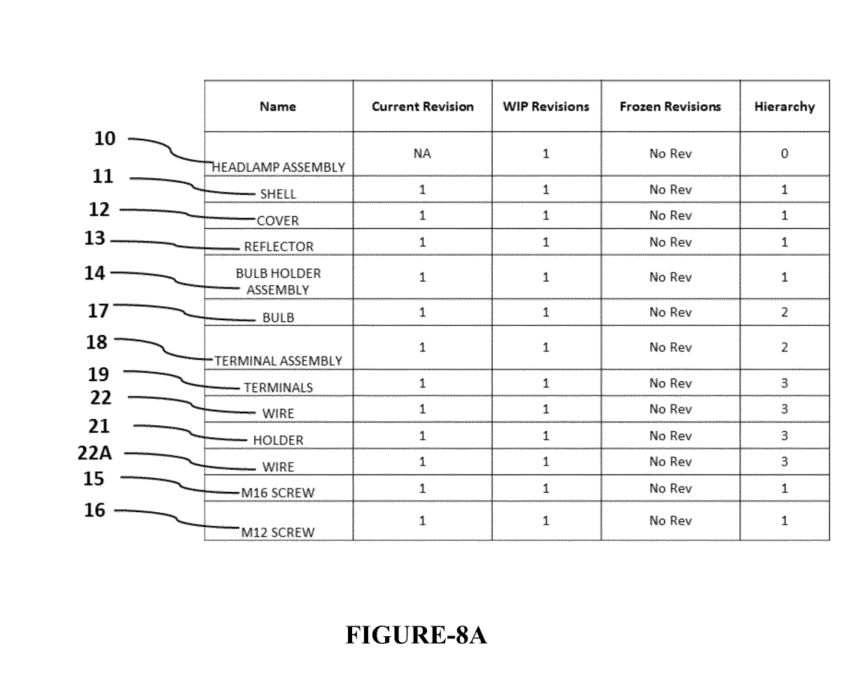

Bulk or individual Record Accessing (43): FIG. 8 is flow diagram showing execution steps in bulk or individual record accessing. Individual access refers to accessing attributes of one part (85), while bulk accessing refers to accessing attributes of a configuration (80), which could be a product or sub-product consisting of several parts (85) or sub assemblies. The notable steps are:
(1) On invoking the “Bulk Display” (43) option of “iArrange” (41), the “plug-in” (40) looks for data entity in tabulation tool (30).
(2) The “plug-in” (40) assesses (121) whether the entity is a configuration (80) or a part (85).
(3) Correspondingly, the “plug-in” (40) fetches attributes (31) corresponding to the parts (85) of the configuration (123), or the plug-in (40) fetches attributes (31) of the Part (85) as per (122).
(4) Report (124) or (125) is generated, according to the embodiment.

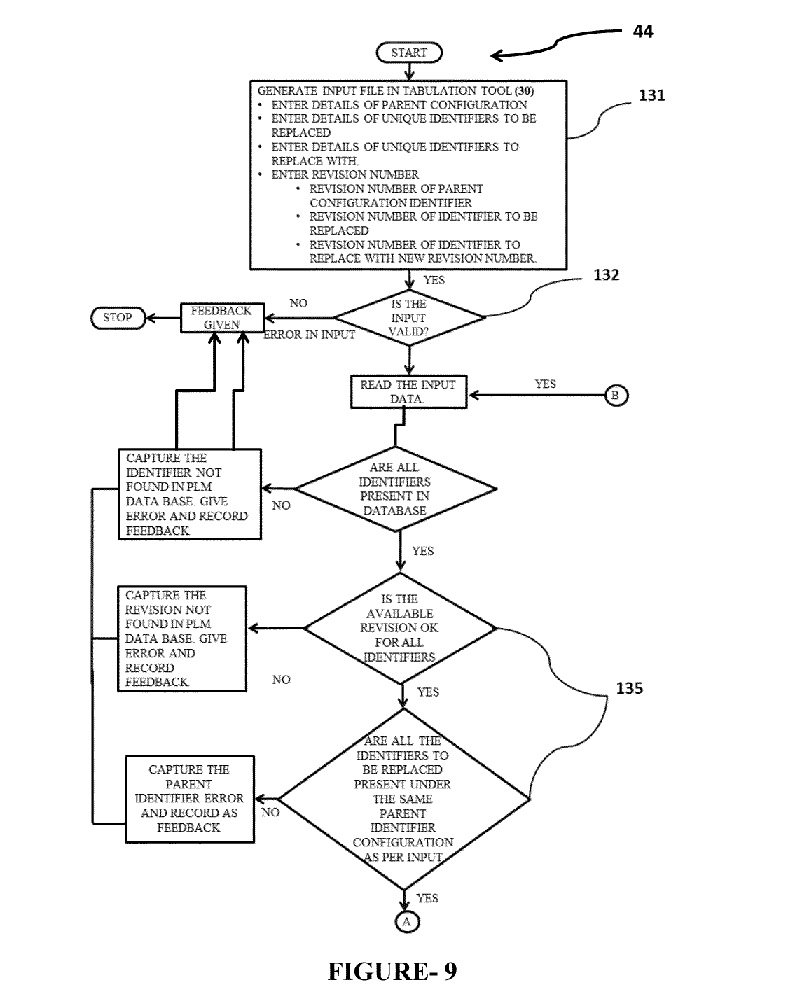

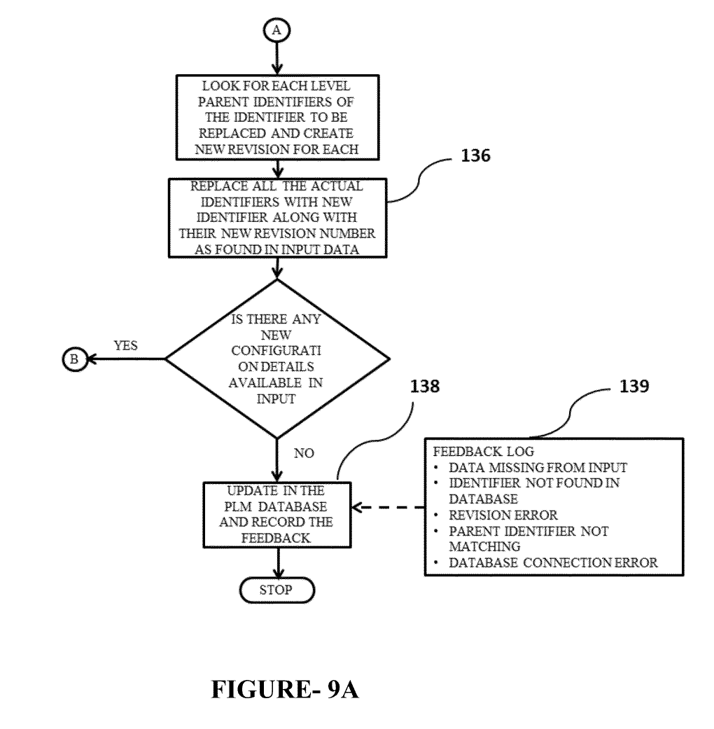

Bulk Updating (44): FIGS. 9 and 9A is flow diagram showing execution steps in bulk updating. The notable steps are
1) On invoking the “Bulk Updating” (44) option of “iArrange” (41), the “plug-in” (40) looks for parent configuration data (131) in tabulation tool (30).
2) Data in each line item is validated by PLM tool as per built-in rules (132).
3) Revision number (63) is updated (136) after validating with respect to previous revision in the PLM database as per (135).
4) Mis-match is reported in the form of a log & feedback table. (139)
5) Updated attributes (31) against individual configuration (80) and parts (85) are created in database of PLM tool (138).

The “plug-in” (40) has built-in rules and data in tabulation tool (30) is checked (132), such that any deviations are reported as error (139), in the following illustrative situations:
Identifier number is different than prescribed naming convention
Wrong Revision number (63) for any identifier (62)
New identifier (62)
User has no read and or write access to the group mentioned
User has no access to the assigned project or program

FIG. 11 and FIG. 13 also show certain illustrative attributes encircled with double line but not described here to avoid unnecessary obscuring, to highlight the additional advantage of the en mass execution, namely—designers can create, without having to work harder, further interlocking cross-intelligence between attributes at different hierarchy levels to extract interdependent information impacting product management.

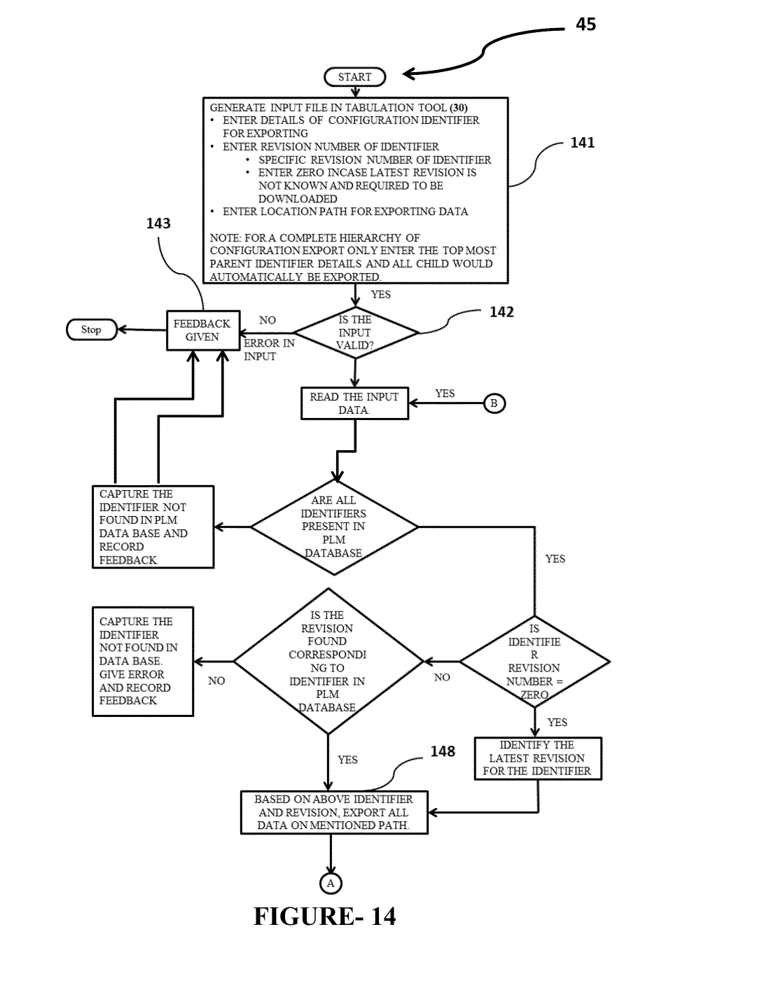

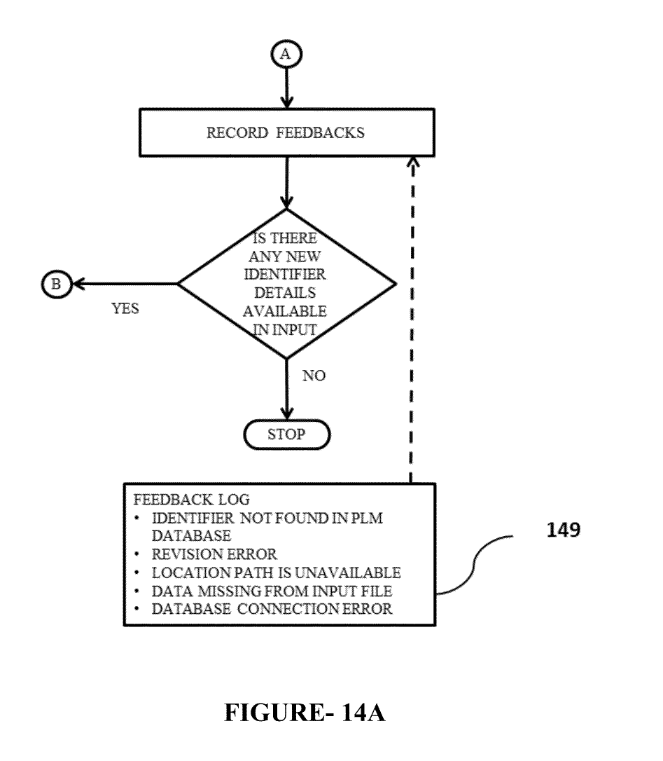

Export of Configurations (45): This option is for obtaining an executable file of attributes data. FIGS. 14 and 14A is flow diagram showing execution steps in bulk export of attributes from PLM tool to Tabulation Tool. The notable steps are
1) On invoking the “Export of Configurations” (45) option of “iArrange” (41), the “plug-in” (40) looks for configuration/identifiers data (141) in tabulation tool (30).
2) Data in each line item is validated by PLM tool as per built-in rules (142).
3) Mis-match is reported in the form of a log & feedback table (143 and 149).
4) Attributes of required parts and sub-assemblies are downloaded at defined location (148).

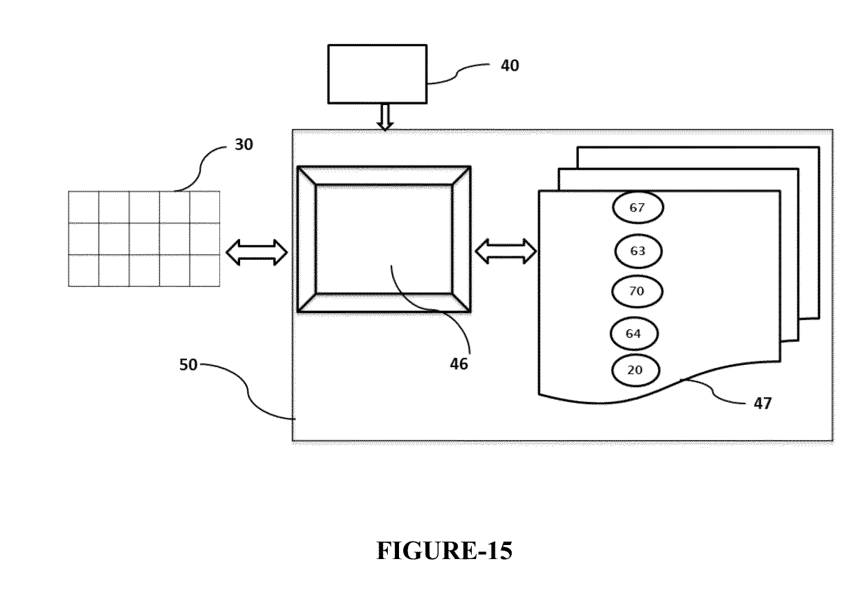

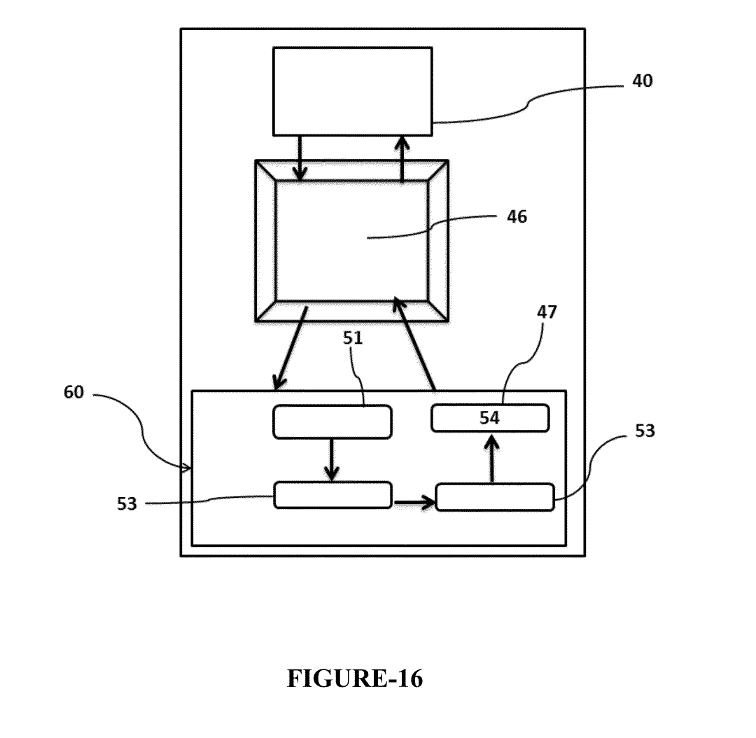

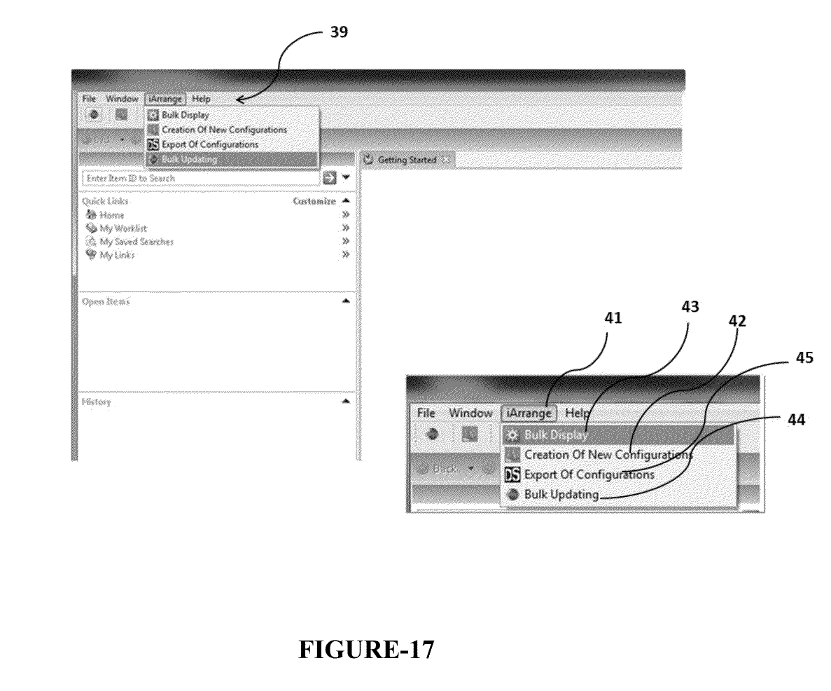

FIG. 15 and FIG. 16 show architecture of “plug-in” (40) with respect to PLM tool (50) and tabulation tool (30), while FIG. 17 gives an illustrative screen of the plug-in “iArrange” (41) as it integrally appears on menu bar (39) of a PLM tool.

On clicking at “iArrange” (41) at menu bar (39) the drop down menu of the features as described in this embodiment appear and the corresponding actions executed as described above.

Architecturally, the PLM tool (50) is broadly divided into three core parts:
(1) PLM Interface (46)
(2) Database (47)
(3) Server having different consoles.(51 52, 53, 54)

The executable code file of plug-in (40) gets installed in the Interface (46) as per procedure of different PLM tools (50), which is made available by the PLM tool supplier and is therefore known, which results in the corresponding icon, in this illustrative case “iArrange” (41), appear on the menu bar (39).

Principally, the database of PLM tool (50) stores all attributes pertaining to every part (85) and configuration (80) when keyed in individually as per intrinsic and conventional method of PLM tools (50).

On clicking the icon of “iArrange” (41) and selecting the desired option, the interface sends command to look for tabulation tool (30) and data file therein at the specified address. On successfully locating the data file, the interface (46) transfers and stores the data on server (60). On instructing the PLM tool (50) to execute, the interface (46) applies rules, matches configuration (80) and identifiers (62) and then creates or changes or supplies required data. Unmatched records are reported as errors.

Within the Server (60), the signal is received by Custom Console (51) which is a customized library in database storing user changes. It then sends the signal to Application Console (52) which manages users' interaction and interface creation. This Application Console (52) then forwards signal to Enterprise Console (53) which is heart of the database managing overall structure and data processing. Finally signal is passed to Server Console (54) where registry and memory are stored. The feedback sent by Server Console (54) then is fed back to User Interface Application (46) which through “plug-in” (40) provides output to the user and thus completes the run of the application.

By enabling en mass, product level execution with PLM tools (50), time to enter inputs in PLM tool (50) is reduced significantly, of the order of more than 50%.

This invention thus
(1) Ensures traceability of product performance and quality through attributes management such that each and every performance parameter or design parameter in every component is inventively linked to product level attribute.
(2) Solves the problem of PLM tools interacting field by field and makes possible en mass execution of attributes.
(3) Provides feedback and error log for mismatches as per prescribed rules.
(4) Reduces time required on Workstation for error-free attributes incorporation in PLM tool.
(5) Reduces time to be invested by designer in incorporating non-performance but important product related parameters.
(6) Provides system such that designers can create, without having to work harder, further interlocking cross-intelligence between attributes at different hierarchy levels to extract interdependent information impacting product management, easily appreciable by persons skilled in the art.

Our inventive system of “plug-in” incorporating our inventive method of hierarchy levels as an attribute, which is corresponding to assembly stages of production line; as also the revision number for all the hierarchy level from the level of design parameter change up to level ZERO, is installable on specific hardware which support industrial PLM tools, example—workstation with 64 bit operating system, NVIDIA Quadro 4000 2 GB GFX Special, and upwards.

The invention is not limited to the gross functions incorporated in our plug-in, which is merely an embodiment with several other options related to en mass management of attributes. Many other benefits related to processing of attributes data can be derived by exploiting our invention, and therefore, the embodiment described hereinabove should not be construed as limiting the invention in any way.

The built-in rules in the “plug-in” are modify-able in synchronism with experiences and needs of an organization and the illustrations described here are by no means a limitation of the “plug-in”.

The words “parts” and “components” are used interchangeably in the above description. The words “Identifier” and “Identification Number” are used interchangeably. The words “plug-in” and “plug-in computer program” are used interchangeably.

We claim:

1) A method for attributes management of product designs, the method comprising the steps of:
(a) Assigning attributive hierarchy levels corresponding to product assembly stages;
(b) Changing revision levels at all the hierarchy levels in a hierarchy chain up to product level for every engineering change of design parameters;
(c) Changing the revision levels at all the hierarchy levels in the hierarchy chain up to the product level for every engineering change of the assembly stages; and
(d) Building an interlocking cross-intelligence between the different attributes.

2) A system and method for attributes management of product designs, comprising of a product life cycle management (PLM) tool and a tabulation tool, characterized in a plug-in computer program, specific to a hardware, which is resident in the PLM interface and causes creation of new configurations, bulk or individual record Accessing, bulk updating, export of configurations by effecting following execution:
a. validation of attribute details incorporated in the tabulation tool;
b. interaction between the tabulation tool and the PLM tool to transact attributes of parts and assemblies at a product level, en mass;
c. generation of error logs and feedback;
d. generation of new and or updated attributes in the PLM; and
e. providing, in user defined manner, the new and or updated attributes and thereby assign attributive hierarchy levels corresponding to product assembly stages; change revision levels at all the hierarchy levels in a hierarchy chain up to the product level for every engineering change of design parameters; change the revision levels at all the hierarchy levels in the hierarchy chain up to the product level for every engineering change of the assembly stages; and build an interlocking cross-intelligence between the different attributes.

3) The system and method for the attributes management of the product designs as claimed in claim 2, wherein said validation is caused as per rules built in the plug-in computer program and rules inherent in the PLM tool.

4) The system and method for the attributes management of the product designs as claimed in claim 2, wherein said interaction by the plug-in computer program executes validated inputs in the PLM tool, en-mass.

5) The system and method for the attributes management of the product designs as claimed in claim 2, wherein said interaction by the plug-in computer program executes so as to create new validated inputs in the PLM tool, en-mass.

6) The system and method for the attributes management of the product designs as claimed in claim 2, wherein said interaction by the plug-in computer program executes so as to update the validated inputs in the PLM tool, en-mass.

7) The system and method for attributes management of product designs as claimed in claim 2, wherein said validated inputs are executed after relating with parent configurations and parts data of the PLM tool.

8) The system and method for attributes management of product designs as claimed in claim 2, wherein said plug-in computer program executes so as to provide, in user defined manner, the new and or updated attributes by generating validated outputs from the PLM tool, en-mass.

9) The system and method for attributes management of product designs as claimed in claim 2, wherein said plug-in computer program executes so as to provide in user defined manner the new and or updated attributes by generating the validated outputs in the form of displays, reports and or executable files from the database of the PLM tool, en-mass.

10) The system and method for attributes management of product designs as claimed in claim 2, wherein said plug-in computer program executes the interlocking cross-intelligence between the attributes.

11) The system and method for attributes management of product designs as hereinabove described in the specification with reference to the accompanying drawings.
